(19) United States
(12) Patent Application Publication
(10) Pub. No.: US 2007/0002591 A1
(43) Pub. Date: Jan. 4, 2007

(54) Light guide plate with protrusion, backlight module with same, and LCD device with same

(75) Inventors: Cheng-Fang Chang, Miao-Li (TW); Ching-Tung Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/479,821

(22) Filed: Jun. 29, 2006

(30) Foreign Application Priority Data
Jul. 1, 2005 (TW) 94211127

(51) Int. Cl. F21V 7/04

(52) U.S. Cl. 362/633; 362/632

(57) ABSTRACT

An exemplary a light guide plate (11) includes a top surface (112), a bottom surface (113) opposite to the top surface, and a side surface (114) between the top surface and the bottom surface. A protrusion (116) extends from the side surface. A thickness of at least part of the protrusion decreases with increasing distance away from the side surface. A backlight module (10) and a liquid crystal display device (1) employing such a light guide plate are also provided.

### FIELD OF THE INVENTION

The present invention relates to light guide plates, and more particularly to a light guide plate configured to be stably and compactly retained in a frame of a backlight module of a liquid crystal display (LCD) device.

### GENERAL BACKGROUND

Liquid crystal displays are commonly used as display devices for compact electronic apparatuses, because they not only provide good quality images with little power but are also very thin. The liquid crystal molecules in a liquid crystal display do not emit any light themselves. The liquid crystal molecules have to be lit by a light source so as to clearly and sharply display text and images. Thus, a backlight module for a liquid crystal display is generally needed.

A typical backlight module generally includes a plastic frame and a light guide plate (LGP). The light guide plate can be positioned in the plastic frame by way of a plurality of rectangular protrusions at a side surface of the light guide plate engaging in a plurality of corresponding grooves of the plastic frame. On the one hand, to make the backlight module stable, the protrusions can be made to have a same thickness as that of the light guide plate, and the plastic frame can be made to be a little thicker than the protrusions. However, this configuration means that the backlight module has an increased thickness. On the one hand, to make the backlight module thin, the protrusions can be made to be thinner than the light guide plate. However, with this configuration, it is difficult to manufacture the protrusions, and the strength of the protrusions is reduced. If one or more of the protrusions fractures or breaks, the backlight module may become unstable.

What is needed, therefore, is a light guide plate that can overcome the above-described deficiencies. What are also needed are a backlight module and a liquid crystal display device employing such a light guide plate.

### SUMMARY

In a preferred embodiment, a light guide plate includes a top surface, a bottom surface opposite to the top surface, and a side surface between the top surface and the bottom surface. A protrusion extends from the side surface. A thickness of at least part of the protrusion decreases with increasing distance away from the side surface. A backlight module and a liquid crystal display device employing such a light guide plate are also provided.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is an exploded, side view of a liquid crystal display device employing a backlight module according to a first embodiment of the present invention.

FIG. 2 is an exploded, isometric view of the backlight module of FIG. 1, the backlight module employing a light guide plate according to a first embodiment of the present invention.

FIG. 3 is an enlarged view of a circled portion III of FIG. 2.

FIG. 4 is similar to FIG. 3, but showing a corresponding view in the case of a light guide plate according to a second embodiment of the present invention.

FIG. 5 is similar to FIG. 3, but showing a corresponding view in the case of a light guide plate according to a third embodiment of the present invention.

FIG. 6 is similar to FIG. 3, but showing a corresponding view in the case of a light guide plate according to a fourth embodiment of the present invention.

FIG. 7 is similar to FIG. 3, but showing a corresponding view in the case of a light guide plate according to a fifth embodiment of the present invention.

FIG. 8 is similar to FIG. 3, but showing a corresponding view in the case of a light guide plate according to a sixth embodiment of the present invention.

FIG. 9 is similar to FIG. 3, but showing a corresponding view in the case of a light guide plate according to a seventh embodiment of the present invention.

FIG. 10 is similar to FIG. 3, but showing a corresponding view in the case of a light guide plate according to an eighth embodiment of the present invention.

### DETAILED DESCRIPTION OF PREFERRED EMBODIMENTS

Reference will now be made to the drawings to describe the preferred embodiments in detail.

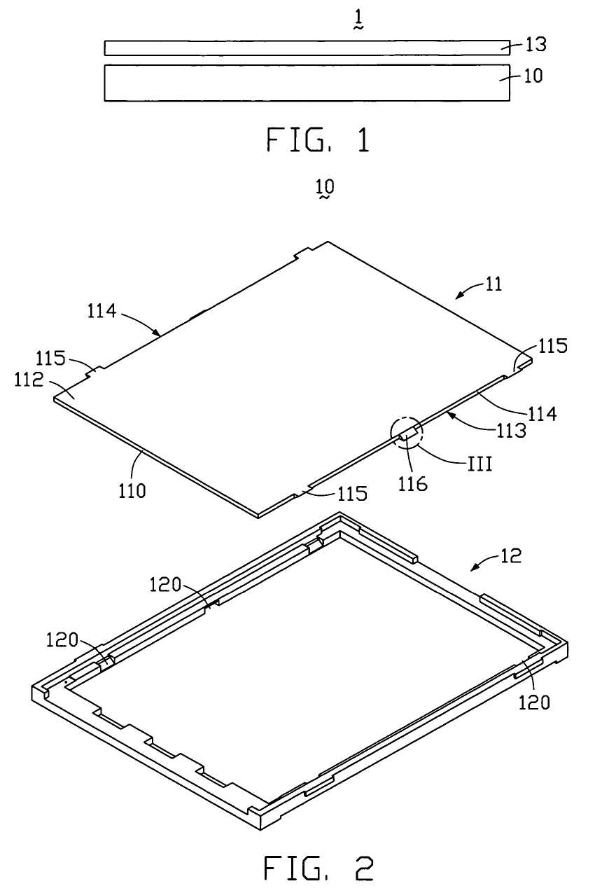

Referring to FIG. 1, a liquid crystal display device 1 includes a backlight module 10, and a liquid crystal panel 13 positioned adjacent to the backlight module 10. Referring to FIG. 2, the backlight module 10 includes a light guide plate 11, and a plastic frame 12 for positioning the light guide plate 11 therein. The light guide plate 11 includes a light incident surface 110, a top surface 112 adjacent the light incident surface 110, a bottom surface 113 opposite to the top surface 112, and two opposite side surfaces 114 each adjacent to the light incident surface 110. Each side surface 114 has two first protrusions 115 and a second protrusion 116 each integrally extending therefrom. The first protrusions 115 are arranged near two ends of the side surface 114 respectively, and the second protrusion 116 is arranged between the first protrusions 115. Each of the first and second protrusions 115, 116 has a same sized triangular cross-sectional configuration. However, the first protrusions 115 have a same orientation, and the second protrusion 116 has an orientation which is inverted relative to the orientation of the first protrusions 115. The plastic frame 12 includes a plurality of grooves 120 respectively corresponding to the first protrusions 115 and the second protrusion 116 of the light guide plate 11.

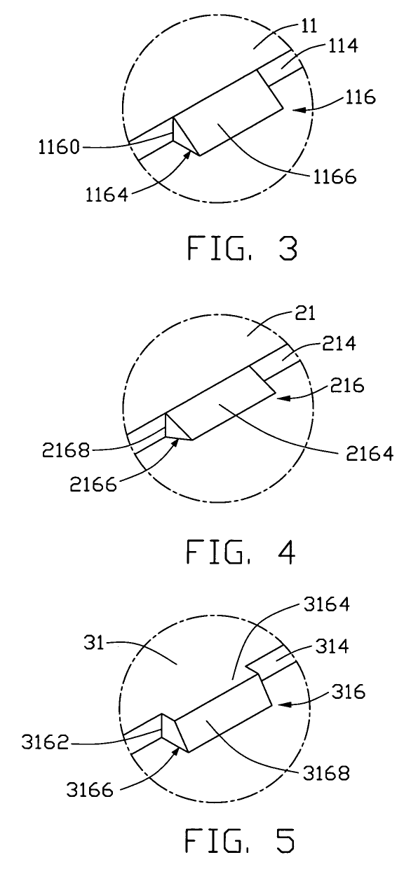

Referring also to FIG. 3, the second protrusion 116 has a right-angled triangle profile. The second protrusion 116 defines a two-dimensional inmost extremity 1160 where it integrally extends from the side surface 114 of the light guide plate 11, a lower surface 1164 perpendicularly adjoining the inmost extremity 1160, and an upper surface 1166 adjoining the inmost extremity 1160 and the lower surface 1164. A height of the inmost extremity 1160 is the same as that of the side surface 114. A thickness of the second protrusion 116 decreases from an inmost end thereof at the side surface 114 to an outmost end thereof. That is, the second protrusion 116 is wedge-shaped, with the lower surface 1164 being coplanar with the bottom surface 113 of the light guide plate 11, and the upper surface 1166 adjoining the top surface 112 of the light guide plate 11. The first protrusions 115 and the second protrusion 116 can be manufactured by an injection molding method together with the light guide plate 11.

The height of the inmost extremity 1160 of each second protrusion 116 is the same as that of the side surface 114, which enables the second protrusion 116 to have good mechanical strength even when the light guide plate 11 is very thin. Similarly, each first protrusion 115 can have good mechanical strength even when the light guide plate 11 is very thin. Moreover, the corresponding groove 120 of the plastic frame 12 is wedge-shaped in a configuration complementary to the wedge shape of the second protrusion 116. That is, a height of the groove 120 progressively decreases from an inmost end thereof to an outmost end thereof. Correspondingly, a height of the plastic frame 12 at the groove 120 progressively increases from the inmost end of the groove 120 to the outmost end of the groove 120. This enables a portion of the plastic frame 12 at the groove 120 to have relatively high mechanical strength. Similarly, portions of the plastic frame 12 at the grooves 120 corresponding to the first protrusions 115 also can have relatively high mechanical strength. Thus the plastic frame 12 overall has good mechanical strength. For all these reasons, the backlight module 10 can have good mechanical strength even if the light guide plate 11 is very thin.

Referring to FIG. 4, a light guide plate 21 according to a second embodiment of the present invention is similar to the light guide plate 11 of the first embodiment. However, in the light guide plate 21, each of protrusions 216 at two side surfaces 214 has an isosceles triangle profile. Each protrusion 216 defines a two-dimensional inmost extremity 2168 where it integrally extends from the side surface 214, a lower surface 2166 obliquely adjoining the inmost extremity 2168, and an upper surface 2164 obliquely adjoining the inmost extremity 2168 and adjoining the lower surface 2166. That is, the protrusion 216 is wedge-shaped, with the lower surface 2166 and the upper surface 2164 having a same size and adjoining the inmost extremity surface 2168 at a same oblique angle.

Referring to FIG. 5, a light guide plate 31 according to a third embodiment of the present invention is similar to the light guide plate 11 of the first embodiment. However, in the light guide plate 31, each of protrusions 316 at two side surfaces 314 has a trapezoidal profile. Each protrusion 316 defines a two-dimensional inmost extremity 3162 where it integrally extends from the side surface 314, an upper surface 3164 perpendicularly adjoining the inmost extremity 3162, a lower surface 3166 perpendicularly adjoining the inmost extremity 3162, and a lateral surface 3168 obliquely adjoining the upper surface 3164 and the lower surface 3166. That is, the protrusion 316 is generally wedge-shaped, with the upper surface 3164 being coplanar with a top surface (not labeled) of the light guide plate 31, and the lower surface 3166 being coplanar with a bottom surface (not labeled) of the light guide plate 31 and having a size greater than that of the upper surface 3164.

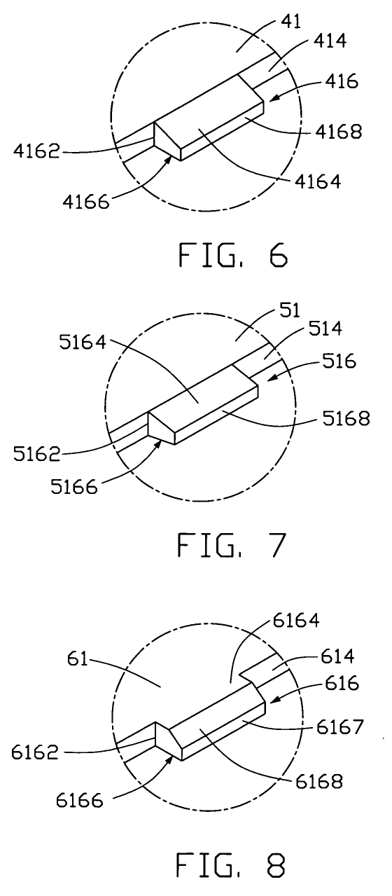

Referring to FIG. 6, a light guide plate 41 according to a fourth embodiment of the present invention is similar to the light guide plate 11 of the first embodiment. However, in the light guide plate 41, each of protrusions 416 at two side surfaces 414 has a trapezoidal profile. Each protrusion 416 defines a two-dimensional inmost extremity 4162 where it integrally extends from the side surface 414, an upper surface 4164 obliquely adjoining the inmost extremity 4162, a lower surface 4166 perpendicularly adjoining the inmost extremity 4162, and a lateral surface 4168 obliquely adjoining the upper surface 4164 and perpendicularly adjoining the lower surface 4166. That is, the protrusion 416 is generally wedge-shaped, with the lower surface 4166 being coplanar with a bottom surface (not labeled) of the light guide plate 41, and the lateral surface 4168 being parallel to the side surface 414.

Referring to FIG. 7, a light guide plate 51 according to a fifth embodiment of the present invention is similar to the light guide plate 41 of the fourth embodiment. However, in the light guide plate 51, each of protrusions 516 at two side surfaces 514 has another kind of trapezoidal profile. Each protrusion 516 defines a two-dimensional inmost extremity 5162 where it integrally extends from the side surface 514, an upper surface 5164 obliquely adjoining the inmost extremity 5162, a lower surface 5166 obliquely adjoining the inmost extremity 5162, and a lateral surface 5168 obliquely adjoining the upper surface 5164 and the lower surface 5166. That is, the protrusion 516 is generally wedge-shaped, with the upper surface 5164 and the lower surface 5166 having a same size and adjoining the inmost extremity 5162 at a same oblique angle, and the lateral surface 5168 being parallel to the side surface 514.

Referring to FIG. 8, a light guide plate 61 according to a sixth embodiment of the present invention is similar to the light guide plate 11 of the first embodiment. However, in the light guide plate 61, each of protrusions 616 at two side surfaces 614 has a pentagonal profile. Each protrusion 616 defines a two-dimensional inmost extremity 6162 where it integrally extends from the side surface 614, an upper surface 6164 perpendicularly adjoining the inmost extremity 6162, a lower surface 6166 perpendicularly adjoining the inmost extremity 6162, a first lateral surface 6167 perpendicularly adjoining the lower surface 6166, and a second lateral surface 6168 obliquely adjoining the upper surface 6164 and the first lateral surface 6167. That is, the protrusion 616 is generally wedge-shaped, with the upper surface 6164 being coplanar with a top surface (not labeled) of the light guide plate 61, the lower surface 6166 being coplanar with a bottom surface (not labeled) of the light guide plate 61, and the second lateral surface 6168 being parallel to the side surface 614.

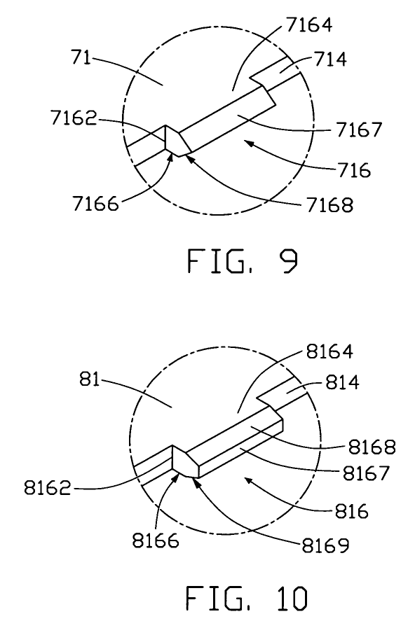

Referring to FIG. 9, a light guide plate 71 according to a seventh embodiment of the present invention is similar to the light guide plate 11 of the first embodiment. However, in the light guide plate 71, each of protrusions 716 at two side surfaces 714 has a pentagonal profile. Each protrusion 716 defines a two-dimensional inmost extremity 7162 where it integrally extends from the side surface 714, a top surface 7164 perpendicularly adjoining the inmost extremity 7162, an upper surface 7166 perpendicularly adjoining the inmost extremity 7162, a first lateral surface 7167 obliquely adjoining the upper surface 7164, and a second lateral surface 7168 obliquely adjoining the upper surface 7166 and adjoining the first lateral surface 7167. That is, the protrusion 716 is generally wedge-shaped, with the upper surface 7164 being coplanar with a top surface (not labeled) of the light guide plate 71, the lower surface 7166 being coplanar with a bottom surface (not labeled) of the light guide plate 71, and the first lateral surface 7167 and the second lateral surface 7168 having a same size and respectively adjoining the upper surface 7164 and the lower surface 7166 at a same oblique angle.

Referring to FIG. 10, a light guide plate 81 according to an eighth embodiment of the present invention is similar to the light guide plate 71 of the seventh embodiment. However, in the light guide plate 81, each of protrusions 816 at two side surfaces 814 has a hexagonal profile. Each protrusion 816 defines a two-dimensional inmost extremity 8162 where it integrally extends from the side surface 814, an upper surface 8164 perpendicularly adjoining the inmost extremity 8162, a lower surface 8166 perpendicularly adjoining the inmost extremity 8162, a first lateral surface 8168 obliquely adjoining the upper surface 8164, a second lateral surface 8169 obliquely adjoining the lower surface 8166, and a third lateral surface 8167 obliquely adjoining the first lateral surface 8168 and the second lateral surface 8169. That is, the protrusion 816 is generally wedge-shaped, with the upper surface 8164 being coplanar with a top surface (not labeled) of the light guide plate 81, the lower surface 8166 being coplanar with a bottom surface (not labeled) of the light guide plate 81, the first lateral surface 8168 and the second lateral surface 8169 having a same size and respectively adjoining the upper surface 8164 and the lower surface 8166 at a same oblique angle, and the third lateral surface 8167 being parallel to the side surface 814.

Further or alternative embodiments may include the following. There can be only one first protrusion and one second protrusion positioned at each of one or more side surfaces of the light guide plate. There can be only one first protrusion positioned at each of one or more side surfaces of the light guide plate. There can be only one second protrusion positioned at each of one or more side surfaces of the light guide plate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate comprising:
a top surface;
a bottom surface opposite to the top surface; and
a side surface between the top surface and the bottom surface, a protrusion extending from the side surface;
wherein a thickness of at least part of the protrusion decreases with increasing distance away from the side surface.

2. The light guide plate as claimed in claim 1, wherein the protrusion is integrally formed with the side surface.

3. The light guide plate as claimed in claim 1, wherein a height of an inmost extremity of the protrusion is the same as that of the side surface of the light guide plate.

4. The light guide plate as claimed in claim 1, wherein the protrusion defines a triangular profile, as viewed from a direction perpendicular to a direction in which the protrusion extends away from the side surface of the light guide plate.

5. The light guide plate as claimed in claim 4, wherein the triangular profile is a right-angled triangle profile.

6. The light guide plate as claimed in claim 5, wherein the protrusion comprises a surface perpendicular to the side surface of the light guide plate.

7. The light guide plate as claimed in claim 4, wherein the triangular profile is an isosceles triangle profile.

8. The light guide plate as claimed in claim 1, wherein the protrusion defines a polygonal profile, as viewed from a direction perpendicular to a direction in which the protrusion extends away from the side surface of the light guide plate.

9. The light guide plate as claimed in claim 8, wherein the polygonal profile is a trapezoidal profile.

10. The light guide plate as claimed in claim 9, wherein the trapezoidal profile is a right-angled trapezoid profile.

11. The light guide plate as claimed in claim 9, wherein the trapezoidal profile is an isosceles trapezoid profile.

12. The light guide plate as claimed in claim 8, wherein the polygonal profile is a pentagonal profile.

13. The light guide plate as claimed in claim 8, wherein the polygonal profile is a hexagonal profile.

14. The light guide plate as claimed in claim 8, wherein the protrusion comprises a surface perpendicular to the side surface of the light guide plate.

15. The light guide plate as claimed in claim 8, wherein the protrusion comprises a surface parallel to the side surface of the light guide plate.

16. The light guide plate as claimed in claim 8, wherein the protrusion comprises a surface oblique to the side surface of the light guide plate.

17. The light guide plate as claimed in claim 1, wherein a height of the protrusion at the side surface of the light guide plate is the same as a height of the side surface.

18. The light guide plate as claimed in claim 1, wherein the protrusion is generally wedge-shaped.

19. A backlight module comprising:
a light guide plate, comprising:
a top surface;
a bottom surface opposite to the top surface; and
a side surface between the top surface and the bottom surface, a protrusion extending from the side surface; and
a plastic frame for holding the light guide plate therein, and comprising a groove for receiving the protrusion of the light guide plate;
wherein a thickness of at least part of the protrusion decreases with increasing distance away from the side surface.

20. A liquid crystal display device comprising:
a liquid crystal panel; and
a backlight module positioned adjacent to the liquid crystal panel, the backlight module comprising:
a light guide plate, comprising:
a top surface;
a bottom surface opposite to the top surface; and
a side surface between the top surface and the bottom surface, a protrusion extending from the side surface; and
a plastic frame for holding the light guide plate therein, and comprising a groove for receiving the protrusion of the light guide plate;
wherein a thickness of at least part of the protrusion decreases with increasing distance away from the side surface.
